(19) United States
(12) Patent Application Publication
(10) Pub. No.: US 2025/0106363 A1
(43) Pub. Date: Mar. 27, 2025

(54) COMPREHENSIVE FACILITY PLANNING AND MONITORING, AND SECURE TRANSACTION PROCESSING SYSTEM

(71) Applicant: Israel Arroyo, Westerville, OH (US)

(72) Inventor: Israel Arroyo, Westerville, OH (US)

(21) Appl. No.: 18/974,140

(22) Filed: Dec. 9, 2024

Related U.S. Application Data
(63) Continuation-in-part of application No. 18/095,476, filed on Jan. 10, 2023.
(60) Provisional application No. 63/297,819, filed on Jan. 10, 2022.

(51) Int. Cl. H04N 7/18; G06V 20/52

(52) U.S. Cl. CPC H04N 7/183; G06V 20/52

(57) ABSTRACT

A dynamic web platform equipped with a client-server architecture for providing detailed views of network devices, live traffic, and comprehensive user and device management. The system includes an application coupled to a server for accessing the functionalities offered by the server. The server includes a plurality of modules for providing a dashboard, a dangerous objects detection, and a real time notification to authorized users. The system uses AI for detecting dangerous objects. In one embodiment, the invention includes a secure payment processing system that leverages a multi-factor authentication device and cryptographic functions within a mobile application and server setup. A public key from the mobile application is compared with a derived public key by the multifactor device for authorizing a transaction.

### CROSS-REFERENCE TO RELATED APPLICATION

The present application is a continuation in part application of, and claims priority to and the benefit of, U.S. Non-Provisional application Ser. No. 18/095,476, which was filed on Jan. 10, 2023, and which claims priority to, and the benefit of U.S. Provisional Application No. 63/155,538, which was filed on Mar. 2, 2021, both of which are incorporated herein by reference in its entirety.

### FIELD OF THE INVENTION

The present invention relates generally to the field of facility management and planning systems. More specifically, the present invention relates to a novel comprehensive security system that enables users to configure a facility in the system for monitoring the facility, detecting weapons or dangerous items (i.e., firearms), and sending real-time notifications. The system also includes a camera system for recording facilities and for work with an object detection module for detecting dangerous items. The invention also includes a secure transaction processing system. The system includes a mobile application and a multifactor device for authorizing a transaction using public keys from the application and the multifactor device. Accordingly, the present disclosure makes specific reference thereto. Nonetheless, it is to be appreciated that aspects of the present invention are also equally applicable to other like applications, devices, and methods of manufacture.

### BACKGROUND

By way of background, facilities such as schools, colleges, emergency areas, and more have challenges and concerns related to security and monitoring within facilities. Weapons, firearms, and other dangerous items may not be easily detected through conventional monitoring systems, necessitating manual inspections by operators. Manual checking and inspection are ineffective and conventional camera surveillance is ineffective as well. Conventional camera recording does not indicate and notify presence of weapons and other dangerous items. An automated recording and dangerous items detection system is desired to identify specific threats without human intervention.

Current methods of placement of sensors, cameras, and more are ineffective. Many areas and corners of facility floors are not recorded by cameras due to ineffective security planning. Improved facility set up is desired where strategic placement of cameras and sensors, integration of different monitoring technologies, and ensuring all potential vulnerabilities are covered are included.

Conventionally, operators such as security personnels are not automatically informed in the case of a threat, which can delay the process of safety and evacuation. Immediate and automated alert systems could enhance response times and reduce the potential impact of security breaches. An improved security system for facilities is required that provides improved communication within monitoring setups of the facility.

In different facilities, managing the inventory of cameras, sensors, and other security devices is difficult. Manual tracking of the devices is done which is ineffective. Individuals find challenges in tracking device statuses, maintenance needs, and ensuring that all devices are functioning as intended. Individuals desire a system that can effectively manages the device inventory of a facility.

Consumers and service providers are often burdened by credit card fraud and/or theft due to the increase prevalence of skimmers, chip readers, proximity skimmers, and other forms of CCV chip hi-jacking or magnetic strip duplication. Additionally, cryptocurrency keys and credit card data are often stored in plain text on mobile devices leading to an increased risk of theft. Thus, a need exists for technologies that protect such data with multiple layers of security.

There is a need for technologies that offer robust protection for both physical facilities and digital financial data. Individuals desire more advanced surveillance and detection systems for facilities, along with encrypted storage solutions and enhanced authentication mechanisms for financial data.

Therefore, there exists a long felt need in the art for a system that enables users to do facility planning and floor planning. There is also a long felt need in the art for a system that eliminates manual monitoring and tracking of a facility. Additionally, there is a long felt need in the art for a facility monitoring system that enables users to configure a facility, add camera devices, sensors, and designate key monitoring areas. Moreover, there is a long felt need in the art for a system that provides real-time notifications to all stakeholders when a dangerous item is detected in a monitored facility. Further, there is a long felt need in the art for a system that significantly enhances the protection of sensitive financial information against fraud and theft. Furthermore, there is a long felt need in the art for a security system that provides secure identity management authentication and authorization. Finally, there is a long felt need in the art for a security system that reduces manual labor in threat detection and improves the management and operation of security devices in a facility.

The subject matter disclosed and claimed herein, in one embodiment thereof, comprises a facility planning system. The system utilizes a client-server architecture to provide multiple user interfaces for endpoint users, and a mobile application configured to display a dashboard for managing different floors of a facility, accessible via various electronic devices including desktops, notebooks, laptops, handheld computers, touch-sensitive devices, computing devices, smartphones, and smartwatches. The system includes a backend server configured to provide modules for monitoring and planning facilities, accessible by the mobile application via a network. The system is adapted to detect dangerous items, records video, and provide real-time notifications to authorized users. The system can be used along with a transaction security system which uses a multifactor device for digital transaction authorization and processing.

In this manner, the facility planning and monitoring system of the present invention accomplishes all of the forgoing objectives and provides users with a comprehensive security system for facilities to prevent threats and intruders. The system can be accessed using a mobile application that is adapted to provide dashboards and other configuration options for configuring a facility in the system. The system also includes a camera system for recording videos of the facility. A transaction security system is also included in the system for authorizing and processing digital transactions of the users using private and public key systems.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a facility planning system. The system comprises a dynamic web platform designed to monitor and plan facilities such as schools, emergency areas, or indoor areas, the system utilizes a client-server architecture to provide multiple user interfaces for endpoint users, and a mobile application configured to display a dashboard for managing different floors of a facility, accessible via various electronic devices including desktops, notebooks, laptops, handheld computers, touch-sensitive devices, computing devices, smartphones, and smartwatches. The system includes a backend server configured to provide modules for monitoring and planning facilities, accessible by the mobile application via a network.

In yet another embodiment, a detailed view module of the facility planning system is configured to provide descriptions and details of network devices and live traffic within a facility, including independent information for different floors of the facility. A facility management module of the facility planning system includes at least one submodule for configuring a facility by adding or removing facilities and modifying facility, and for providing administrative functions and managing license information of the system to subscribers of the system. A settings module is configured as a secured area accessible only by authorized users, for performing administrative functions and managing license information for the system's subscribers.

In yet another embodiment, an object detection module is adapted to identify dangerous items (i.e., firearms, weapons, knives, et. al.) in a live stream video using computer vision and artificial intelligence to enhance the security of the facility wherein a percentage-based confidence rate is generated for each identified item.

In yet another embodiment, an AI logged events module is configured for documenting and analyzing security incidents identified by the object detection module and initiates automatic recording of video streams when firearms are detected, and the recorded data is used for AI training and incident analysis.

In another aspect, a notifications module facilitates communication among registered users of the system for a facility and provides messages based on the role of the users, thereby enabling users to keep track of ongoing discussions or shared information related to facility management and security.

In still another embodiment, a dashboard is designed to provide an overview of authorized information based on the role and permission of the user, displaying metrics for facilities assigned to the logged-in user, including image assets, video assets, and device assets metrics, and enabling tracking of changes in assets over time.

In one embodiment, a secure payment processing system is disclosed and comprises a mobile application adapted to be installed on an electronic computing device, the application is configured to store account information and includes a trusted zone storage for cryptographic functions.

In another embodiment, a method for transaction processing in a secure payment system is disclosed. The method comprises the steps of installing a mobile application on an electronic computing device, wherein the mobile application is configured to store user account information and includes a trusted zone storage, storing a private key within a multi-factor hardware device in the trusted zone storage, wherein the private key is processed using cryptographic functions to derive a corresponding public key address, sending a request message from the mobile application installed on the electronic computing device to the multi-factor hardware device, wherein the request message includes a public key, and comparing, within the multi-factor hardware device, the derived public key address with the public key included in the request message to authorize a user transaction.

A Bluetooth communications server is used within the multi-factor hardware device to compare the public address received from the mobile application with the derived public address from the private key and generating a response message indicating either a successful authorization (“OK”) or a failure (“FAILED”) based on whether the addresses match.

Numerous benefits and advantages of this invention will become apparent to those skilled in the art to which it pertains upon reading and understanding of the following detailed specification.

In yet another embodiment, a camera monitoring system is included within the facility planning system and is designed for real-time surveillance with customizable features, compatible with Pan-Tilt-Zoom (PTZ) cameras and includes a depth perception calculator and an overlay management module for improved surveillance accuracy and visual clarity. A PTZ camera is a robotic camera capable of panning horizontally, tilting vertically, and zooming. PTZ cameras are often positioned at guard posts where active employees may manage them using a remote camera controller.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of facility planning and monitoring system of the present invention in accordance with the disclosed architecture;

FIG. 2 illustrates an exemplary dashboard view of the facility monitoring and threat detection system of the present invention in accordance with the disclosed architecture;

FIG. 3 illustrates a perspective view of the detailed views module of the facility monitoring and threat detection system of the present invention in accordance with the disclosed architecture;

FIG. 4 illustrates a functional block diagram depicting the facility management module of the system in accordance with the disclosed architecture;

FIG. 5 illustrates a user interface displayed by the user management module in accordance with the disclosed architecture;

FIG. 6 illustrates a block diagram of the settings module of the system of the present invention in accordance with the disclosed architecture;

FIG. 7 illustrates a block diagram view of the application offered by the system in accordance with the disclosed architecture;

FIG. 8 illustrates a block diagram depicting a block diagram for the camera monitoring system of the present invention in accordance with one embodiment of the present invention;

FIGS. 9A-9C illustrate block diagram views of the secure payment processing system in accordance with one embodiment of the present invention;

FIG. 10 illustrates an exemplary interface of the mobile application used in the secure payment processing system in accordance with one embodiment of the present invention;

FIG. 11A illustrates an exemplary interface of the mobile application for user onboarding in accordance with one embodiment of the present invention;

FIG. 11B illustrates an exemplary interface of the mobile application for importation of crypto currency private key for public address resolution in accordance with one embodiment of the present invention;

FIG. 11C illustrates an exemplary interface of the mobile application for importation of crypto currency private key from multi-factor hardware device storage in accordance with one embodiment of the present invention;

FIG. 11D illustrates an exemplary interface of the mobile application displaying crypto currency transactions and balance overview in accordance with one embodiment of the present invention;

FIG. 11E illustrates an exemplary interface of the mobile application displaying crypto currency Ethereum token balance overview in accordance with one embodiment of the present invention;

FIG. 11F illustrates an exemplary interface of the mobile application displaying available development options of functions to execute on multi-factor hardware device in accordance with one embodiment of the present invention;

FIG. 11G illustrates an exemplary interface of the mobile application displaying the resulting HOTP 8 Digit Pin Received from the hardware device in accordance with one embodiment of the present invention;

FIG. 11H illustrates an exemplary interface of the mobile application displaying geo-location locking outside of restricted area in accordance with one embodiment of the present invention;

FIG. 11I illustrates an exemplary interface of the mobile application displaying geo-location locking within restricted area in accordance with one embodiment of the present invention; and

FIG. 12 illustrates a process of secure data transmission and record retention using a decentralized networking platform in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system that enables users to do facility planning and floor planning. There is also a long felt need in the art for a system that eliminates manual monitoring and tracking of a facility. Additionally, there is a long felt need in the art for a facility monitoring system that enables users to configure a facility, add camera devices, sensors and designate key monitoring areas. Moreover, there is a long felt need in the art for a system that provides real-time notifications to all stakeholders when a dangerous item is detected in a monitored facility. Further, there is a long felt need in the art for a system that significantly enhances the protection of sensitive financial information against fraud and theft. Furthermore, there is a long felt need in the art for a security system that provides secure identity management authentication and authorization. Finally, there is a long felt need in the art for a security system that reduces manual labor in threat detection and improves the management and operation of security devices in a facility.

The present invention, in one exemplary embodiment, is a method for transaction processing in a secure payment system. The method comprises the steps of installing a mobile application on an electronic computing device, wherein the mobile application is configured to store user account information and includes a trusted zone storage, storing a private key within a multi-factor hardware device in the trusted zone storage, wherein the private key is processed using cryptographic functions to derive a corresponding public key address, sending a request message from the mobile application installed on the electronic computing device to the multi-factor hardware device, wherein the request message includes a public key, and comparing, within the multi-factor hardware device, the derived public key address with the public key included in the request message to authorize a user transaction.

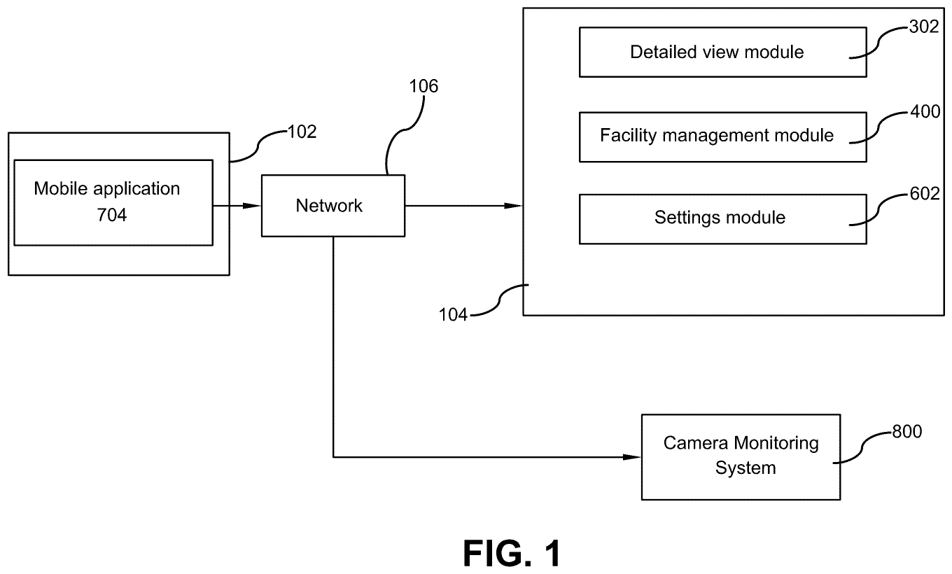

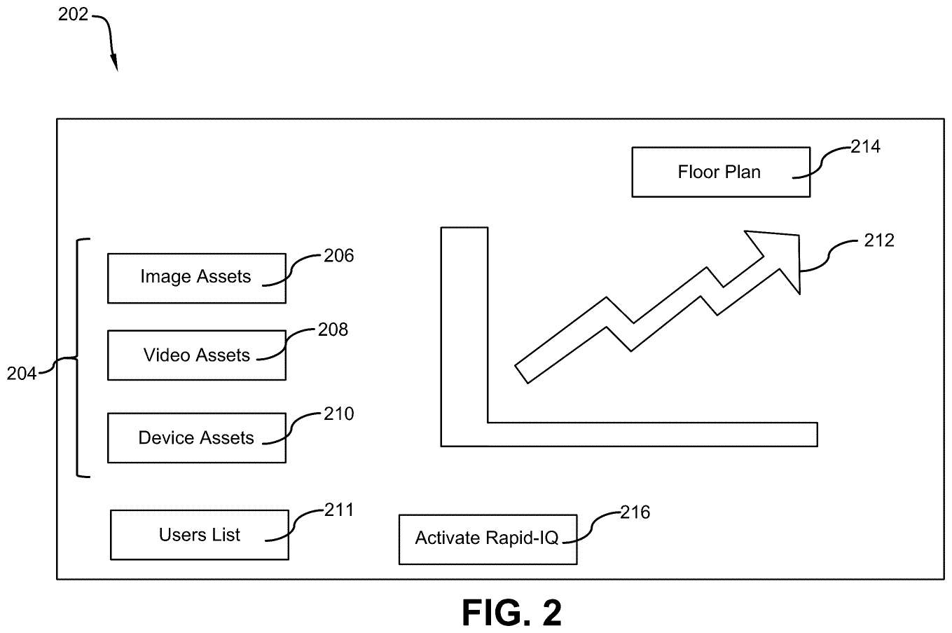

Referring initially to the drawings, FIG. 1 illustrates a schematic view of facility planning and monitoring system of the present invention in accordance with the disclosed architecture. The facility planning system 100 is designed to provide a dynamic web platform for monitoring and planning a facility such as a school, emergency area, or any other indoor area. The system 100 provides a client and server architecture for providing different user interfaces for an endpoint user to use the functionality provided by the system 100. The system 100 provides a mobile application 704 which is configured to display a dashboard as illustrated in FIG. 2 for managing different floors of a facility. The application 704 is accessible in an electronic device 102 and examples of the electronic device 102 can include, but not limited to, a desktop, a notebook, a laptop, a handheld computer, a touch sensitive device, a computing device, a smart-phone, and/or a smart watch. It will be apparent to a person of ordinary skill in the art that the electronic device 102 can include any device/apparatus that is capable of manipulation by the user.

The system 100 uses a backend server 104 that is configured to provide different modules for enabling monitoring and planning of a facility. The application 704 can access the server 104 using a network 106. The server 104 is configured to have the logic, instructions, circuitry, interfaces, and/or codes for executing various operations required for communication between the server 104 and the user device 102. The communication network 106 may include suitable logic, circuitry, and interfaces that may be configured to provide a plurality of network ports and a plurality of communication channels for transmission and reception of data related to operations of various entities (such as the user device 102 and the server system 104) of the system 100. The communication network 106 may be associated with an application layer for implementation of communication protocols based on one or more communication requests from the user device 102 and the server system 104.

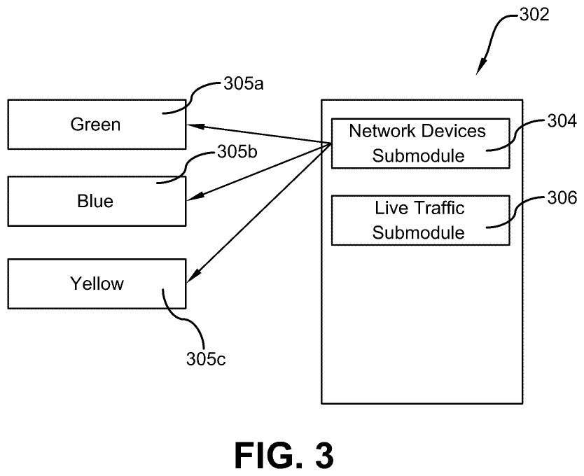

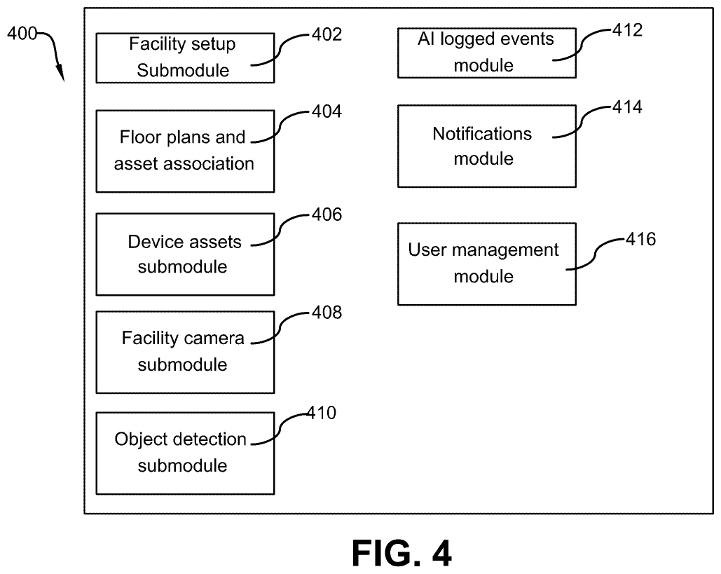

The server 104 includes a detailed view module 302 for providing description and details of network devices and live traffic within a facility as illustrated in FIG. 3. The detailed view module 302 can also provide independent information for different floors of a facility. The facility management module 400 includes a plurality of submodules as described in FIG. 4. More specifically, the facility management module 400 enables users to configure a facility such as adding or removing a facility and can also modify a facility. The settings module 602 is a secured area of the system 100 and is enabled for only authorized users. The settings module 602 can provide administrative functions to authorized administrators and manages the license information of the system 100 to subscribers.

FIG. 2 illustrates an exemplary dashboard view of the facility monitoring and threat detection system of the present invention in accordance with the disclosed architecture. The system 100 provides a dashboard 202 which is designed to be the first interface displayed to a user for interaction after successfully logging into the system 100. The dashboard 202 provides an overview of the authorized information as per role and permission of the user within the system 100.

The dashboard 202 displays metrics 204 for at least one facility assigned to the logged-in user. The displayed metrics 204 can include image assets 206 which include stored images relevant to the operations or security of the facility. Video assets 208 include information on video recordings or surveillance footage of the facility. The video assets 208 are provided by a plurality of cameras positioned in the facility. Device assets metrics 210 include details about physical devices (e.g., security cameras, sensors) installed within the facility. The dashboard 202 also displays a list of users 211 with access or roles within the facility.

The dashboard 202 enables users to track changes 212 in the assets over time. The changes can be displayed using graphs such as displaying for month-to-month basis. The graphs help identify changes within the facility, such as new devices being introduced or modifications to existing assets and for security and operational planning.

A floor plan view option 214 provides a complete 360-degrees view of a floor of the facility. The floor plan view option 214 displays the physical layout of the floor and helps in planning security measures for the floor. The floor plan view option 214 also displays the location of various devices (e.g., security cameras, sensors) positioned within the floor.

In the preferred embodiment, when a user is logged in as an administrator, the user can switch views between different units or sections of the facility for comprehensive control and oversight. The dashboard 202 provides a manual “Activate Rapid-IQ” Button 216 that can be activated by the user to send SMS messages and emails to all assigned users of a unit or facility, facilitating quick dissemination of critical information. Using the “Activate Rapid-IQ” Button 216, the information can be sent within three seconds to users.

FIG. 3 illustrates a perspective view of the detailed views module of the facility monitoring and threat detection system of the present invention in accordance with the disclosed architecture. The “Detailed Views” module 302 in the system 100 is designed to enhance the monitoring and management capabilities of network administrators and security personnel by providing in-depth information on network devices and live traffic conditions. The “Detailed Views” module 302 has a network devices submodule 304 and a live traffic submodule 306.

The network devices submodule 304 is adapted to provide real-time information about the devices included in network. The submodule 304 uses a network scanning tool such as a map scanning tool to identify devices on the network. The submodule 304 performs periodic scanning of the network to detect changes in the network, such as devices joining (via wireless or Ethernet connections), leaving the network (due to disconnection or malfunction), or remaining unchanged.

In the preferred embodiment, the submodule 304 uses color codes to represent different statuses of devices. Green color 305a can be used for devices that correctly connect to the network and are functioning. Blue color 305b can be used for informational purposes about the device status. Yellow color 305c for the devices can indicate potential issues in the devices that require attention from users for correct functioning of the device. The submodule 304 can be used by network administrators to monitor the health and security of the network, detect unauthorized access or removal of network assets, and maintain an overview of network infrastructure.

The live-traffic submodule 306 is designed to aggregate and display live video feeds from traffic cameras across multiple states. The submodule 306 is adapted to collect live video feeds from traffic cameras for monitoring public areas, identifying potential threats, and managing traffic flow.

FIG. 4 illustrates a functional block diagram depicting the facility management module of the system 100 in accordance with the disclosed architecture. The facility management module 400 includes a facility setup submodule 402 that enables the creation, editing, and removal of facilities in the system 100. The submodule 402 enables users to define facilities, delineate units/areas within the defined facilities, and add assets to specific units or areas. The submodule 402 helps in organizing and managing facilities efficiently.

The floor plans and asset association option 404 enables users to attach floor plans to units or areas. The floor plans and asset association option 404 also enables users to append assets like images, videos, cameras, IoT devices, key controls and more to different units and areas. The assets defined using the submodule 402 can be integrated for the metrics reporting visible on the dashboard as described in FIG. 2.

The device assets submodule 406 is adapted to function as an inventory management system for the Internet of things (IoT) and camera device assets within the system 100. The Internet of things describes devices with sensors. processing ability, software and other technologies that connect and exchange data with other devices and systems over the Internet or other communications networks. The Internet of things encompasses electronics, communication, and computer science engineering. The device assets submodule 406 stores all the device assets, including comprehensive details provided by the user during asset registration (such as manufacturer, model number, serial number, facility/unit location, and device type).

The facility camera submodule 408 is adapted to provide a live stream view of the camera devices managed by the system 100. The live stream view can be uniquely identified based on the IP stream address of each camera. Each authorized user is provided a unique URL and corresponding credentials for viewing the live stream view and can be viewed on any compatible browser.

A unique feature of the system 100 is to identify firearm objects and/or weapons within the live stream video using an integrated object detection module 410. The module 410 can identify firearms like pistols, shotguns, or assault rifles with a percentage-based confidence rate. The module 410 can use computer vision and artificial intelligence for identifying dangerous items (i.e., weapons) and provide a confidence rate based on the historical data associated with the objects.

The facility management module 400 includes an AI logged events module 412 for documenting and analyzing security incidents identified by the object detection module 410. When a firearm or weapon is detected in a video stream, the video stream is automatically recorded and is also used for AI training of the AI logged events module 412. Additional details such as area location and the date/time of occurrence of detection of the firearm are included.

The notifications module 414 facilitates communication among the registered users. The notification module 414 provides messages based on role of the users and enables users to review messages and keep track of ongoing discussions or information shared.

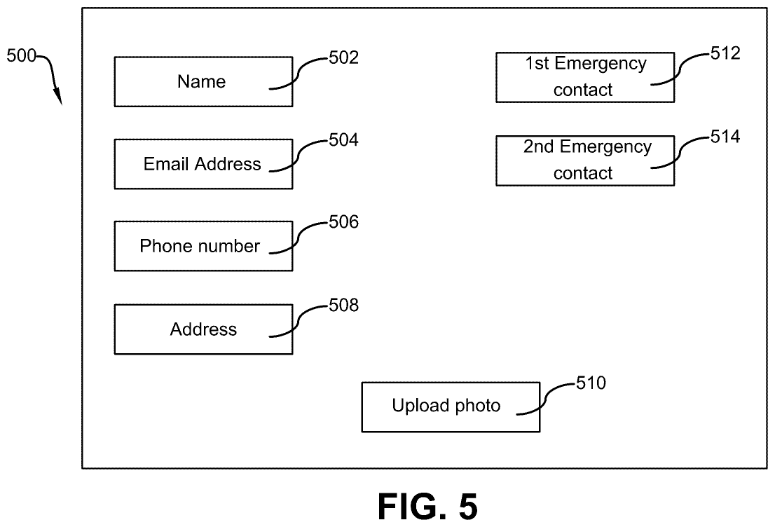

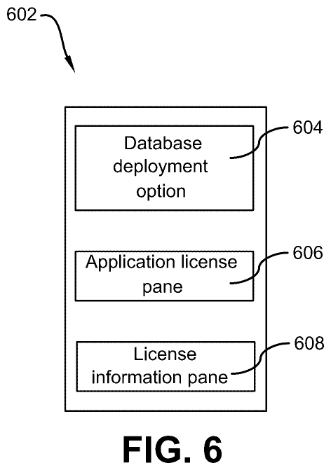

The user management module 416 is adapted to manage and configure different aspects of user profiles and permissions. Using the module 416, an administrator can assign specific roles to users within the application. Users can also be assigned to specific facilities and areas within those facilities. The user management module 416 provides a user interface as illustrated in FIG. 5 for receiving user information of the users for accessing the system 100.

As illustrated in FIG. 5, the user interface 500 provides input boxes 502 for name, an email address input box 504 for receiving email address used for notifications, phone number input boxes 506 for receiving contact information for communication and address input boxes 508. For identification of a user, a user's photo can also be uploaded using the upload photo button 510. For each user, two emergency contacts 512, 514 are received by the user management module 416 enabling administrators or the system to reach out to designated contacts in case of an emergency situation.

Access to the settings module 602 and associated functionality is provided only to the authorized administrators and can require a password for access. A database deployment option 604 provides the ability to authorized administrators to create, update, and copy the databases included in the system 100. An application license pane 606 enables updates to the license information of the application provided by the system 100. The license pane 606 enables for the registration or renewal of the license of the application for different subscribers/customers. A license information pane 608 displays the current status of the license information, including the License Owner, License Start Date, and License End Date.

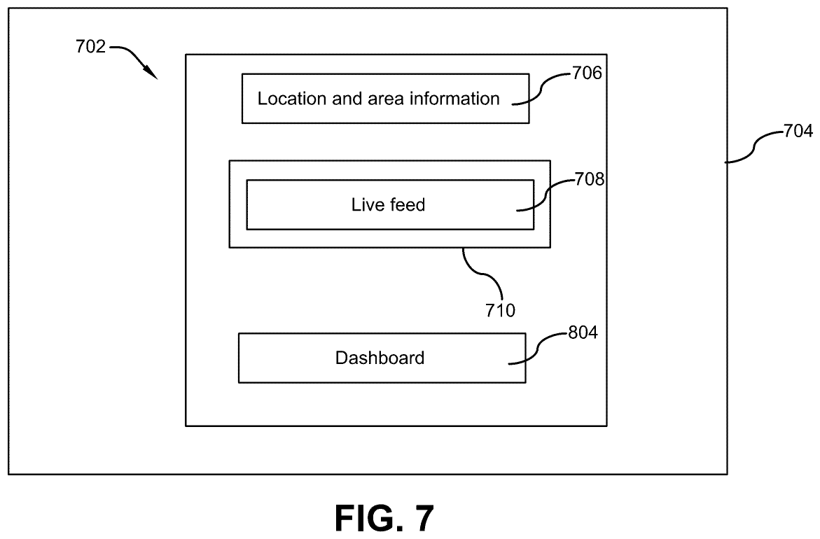

Referring now to FIG. 7, the notification client 702 is a specialized application that can be designed for different operating systems and is adapted to receive push notifications from the server. The notification client 702 provides a direct channel for alerting users about significant events, augmenting other forms of communication like emails or SMS.

In the preferred embodiment, when the object detection system detects an object such as firearms/weapons and logs the event in the AI Logged Events module of the dashboard 202, the notification client 702 triggers an alert to client systems that have the client installed therein. The notification module 702 provides prompt information about the potential security threats.

The notification client 702 also correlates the object detection with the corresponding location of the facility and the camera that identified the firearm or weapon. The information about the location and area information 706 of the detected firearm/weapon, enhance situational awareness and helps in mitigating the threat. The notification client 702 has the capability to automatically open a web browser session 710 in the client system to display the live feed 708 from the camera that detected the firearm/weapon.

In some embodiments, the notification client 702 uses principles from vector-based graphic software, specifically the even-odd rule algorithmic expressions, to determine the relevance of camera locations within a defined video polygon area. Further, by analyzing data from a plurality of cameras, the notification client 702 can provide directions and navigational information regarding the movement or location of potential threats. The notification client 702 operates as a non-interactive background service on desktop computers.

The application 704 can run on different operating systems and can provide a plurality of interfaces and functionalities that allow users to interact with the core features of the platform 100 on their mobile devices. Only authenticated users are enabled to access the platform 100 via the application 704. The mobile application 704 also includes the notification client 702.

Using the mobile application 704, users can manually trigger alerts from their mobile devices and use geo-positioning. Accordingly, when an alert is activated, the system 100 captures and transmits the geographic location of the mobile device, enhancing the response capabilities by providing precise location data. The mobile application 704 also enables the users to view AI-logged events. Upon receiving a notification of an alert from the system 100, the mobile application 704 can automatically launch live streams from cameras relevant to the alert. The mobile application 704 includes a one-click call to emergency services. The one-click call enables users to quickly contact local emergency responders without navigating away from the application 704, streamlining the process of seeking assistance in urgent situations.

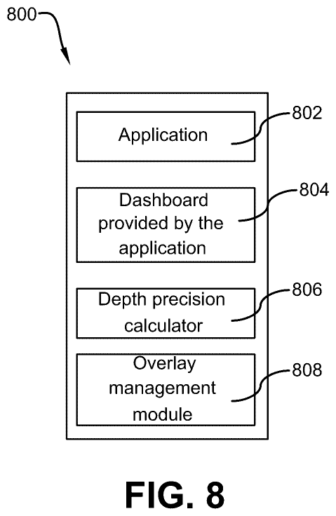

FIG. 8 illustrates a block diagram depicting a block diagram for the camera monitoring system of the present invention in accordance with one embodiment of the present invention. The camera monitoring system 800 includes an application 802 designed to enhance the functionality of command and control centers, such as operation centers and emergency operation centers. The camera monitoring system 800 enables for real-time surveillance with customizable features.

The system 800 is compatible with Pan-Tilt-Zoom (PTZ) cameras, enabling operators to control the movements of the cameras directly through the dashboard 804 provided by the application 802. The system 800 includes a depth perception calculator 806 that is configured to assess the depth of target objects detected by the cameras, thereby enhancing the accuracy of surveillance. An overlay management module 808 enables users to activate or deactivate information overlays for improved visual clarity. The module 808 enables the display of information overlays, including the detection of firearms/weapons and their positivity percentages.

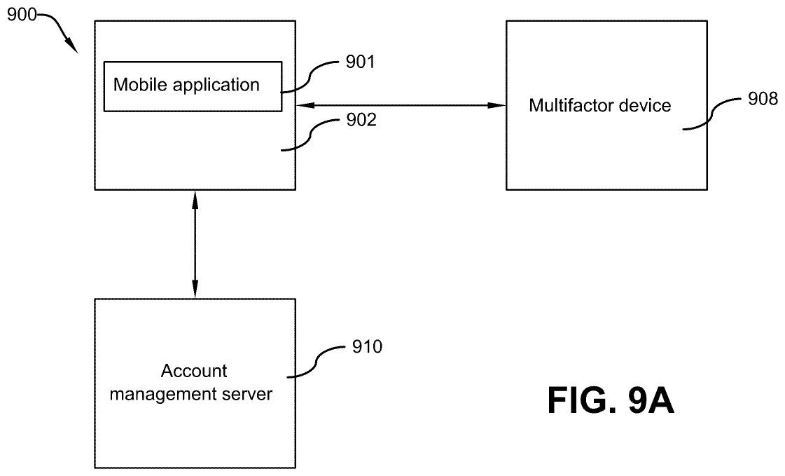

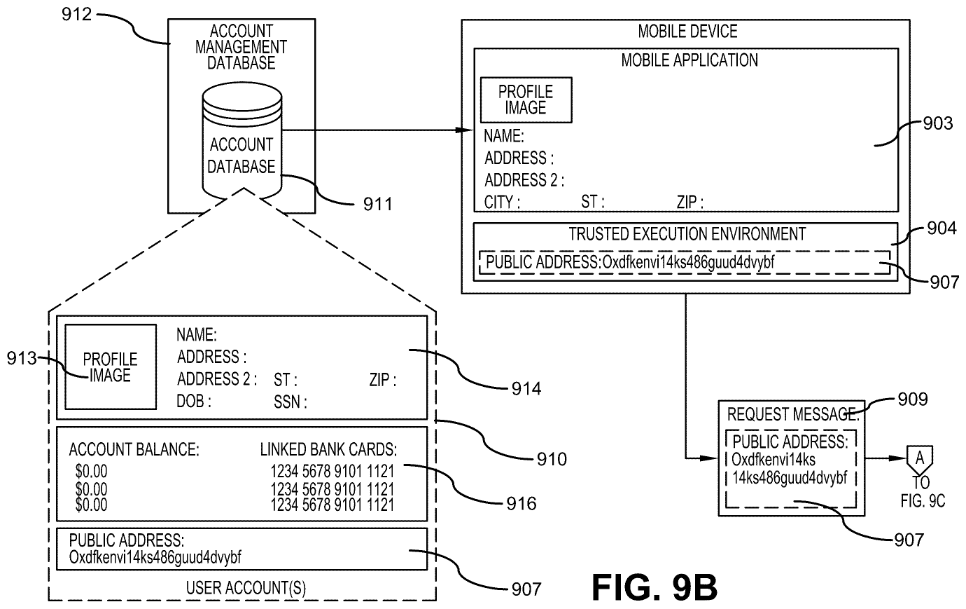

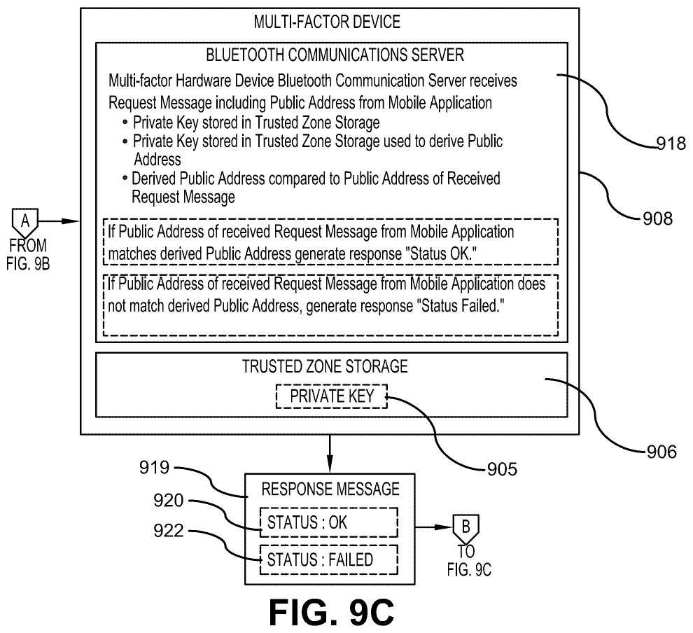

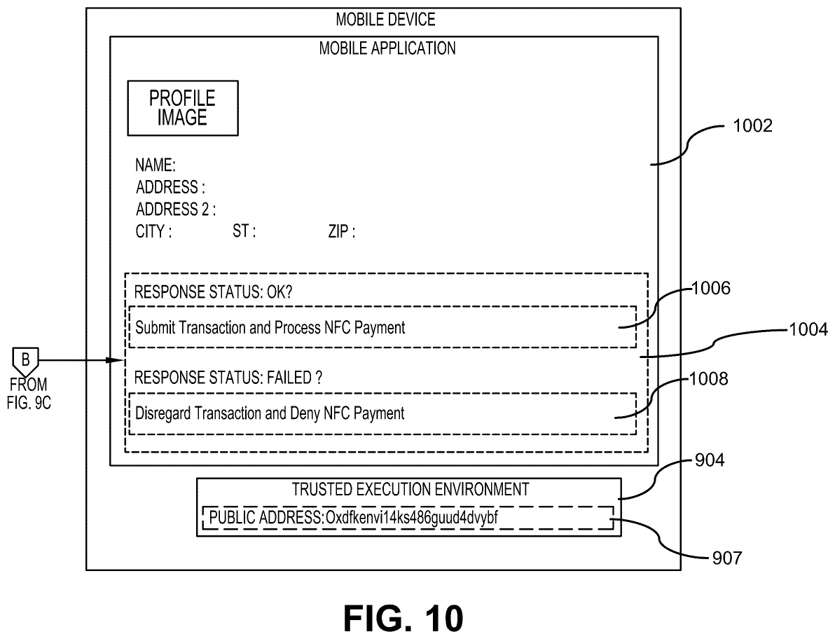

FIGS. 9A and 9B illustrate block diagram views of the secure payment processing system in accordance with one embodiment of the present invention. The system 900 includes a mobile application 901 adapted to be installed on an electronic computing device 902. The mobile application 902 stores account information 903 of a logged-in user and a trusted zone storage 904 as referred to in FIG. 9B.

Referring now to FIG. 9C, a private key 905 is stored in the Multi-Factor Hardware device Trust Zone Storage 906 and is processed using cryptographic functions that derive the private key to a public key address. A public key 907 referenced in the mobile application 901 is received by the multifactor device 908 in a request message 909 sent by the mobile device 902 and the derived public key address (from the private key 905) is compared with the public key 907 for authorization of a user. The private key 905 remains separated from the public key and the private key does not leave the encrypted trust-zone storage 906 of the multifactor device 908.

A hosted user onboarding credentials and account management portal 910 is in the form of a website. When a user is registered, the user is assigned the public address 907 to their account. The public address is derived from the multi-factor device private key which is generated when the account is registered. The private key 905 is imposed to the trusted zone storage on a per registration basis and after storage of the private key, the multifactor device 908 is shipped to the registered user. The multifactor device 908 is verified in the mobile application 901 for successful registration of the multifactor device 908 in the mobile application 901. A database 911 stores the information of the registered users and is configured to display on the portal 910 and the database 911 is hosted in an account management server 912 which can be a cloud server, distributed server, or any other type of conventional server.

As illustrated, the portal 910 displays user profile image 913, personal information 914, list of different bank cards 916 associated with the user profile and the public key address 907. The database 911 is configured to store all the displayed information of the users for display on the portal 910.

The multifactor device 908 includes a Bluetooth communications server 918 which compares the public address 907 of the received message 909 from the mobile application 901 to the derived public address from the private address/key 905 and generates a response message 919 with status “OK” 920 when the addresses matched and generates a status “FAILED” 922 when the addresses do not match each other.

FIG. 10 illustrates an exemplary interface of the mobile application used in the secure payment processing system in accordance with one embodiment of the present invention. As illustrated, the interface 1002 displays a transaction authorization notification 1004 which can be one of a successful transaction authorization 1006 or a failed transaction authorization 1008 based on the processing as described in FIG. 10.

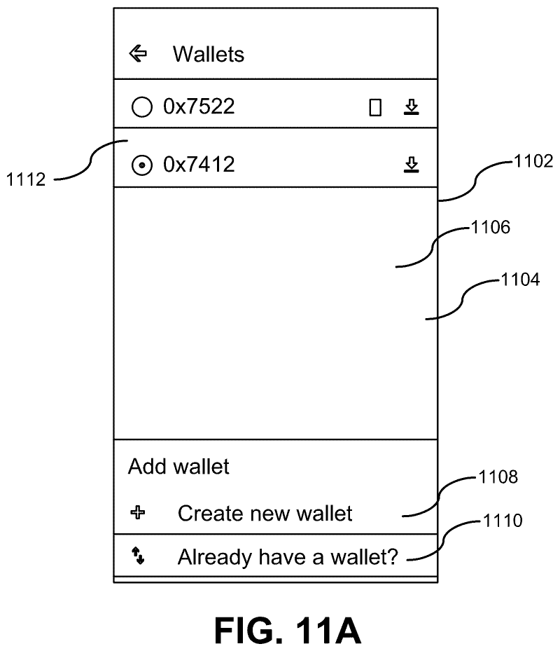

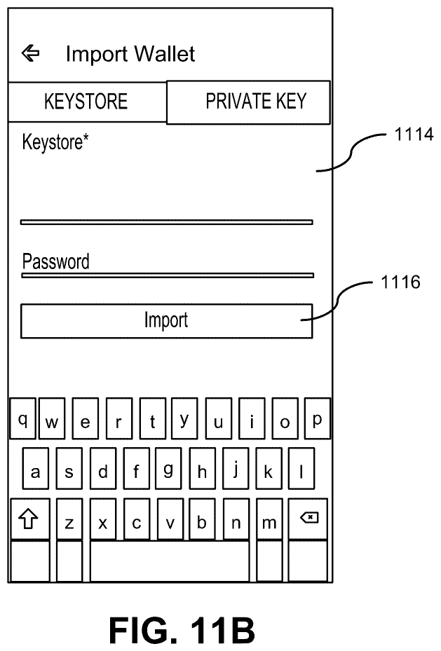

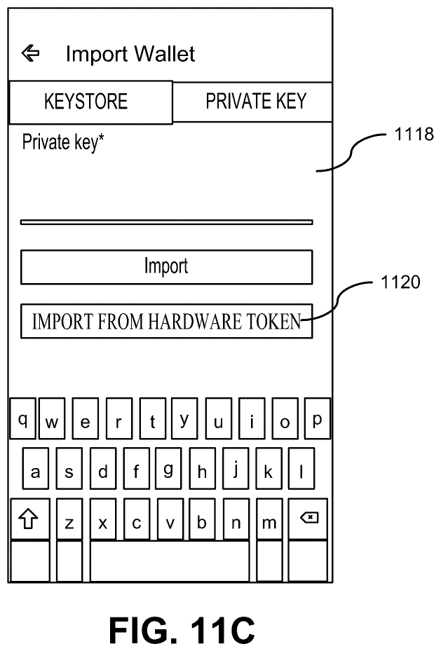

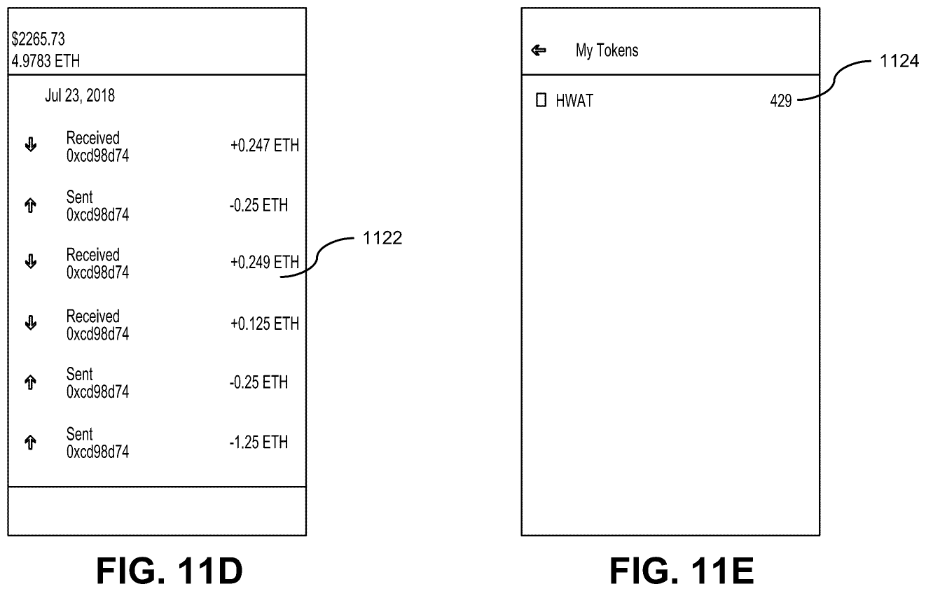

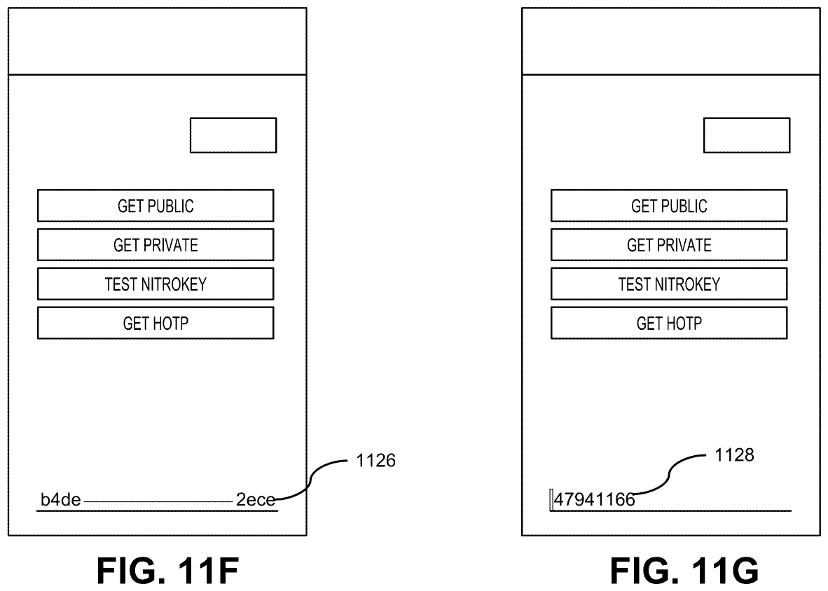

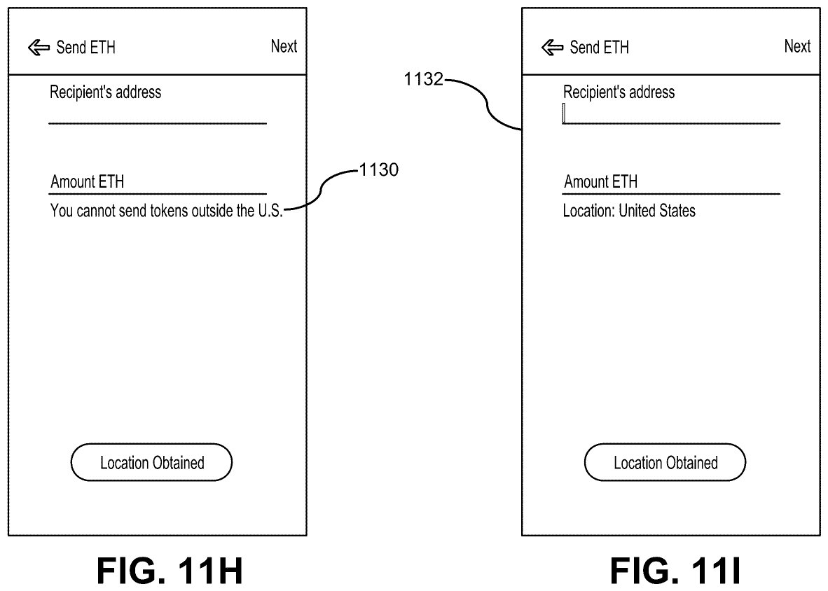

FIGS. 11A-11I illustrate different user interfaces for working with a software-based wallet running on a mobile smart device which is adapted to wirelessly communicate with the multifactor device in accordance with one embodiment of the present invention. The mobile device 1102 is adapted to send geo-location data to the multifactor device 908 for transaction processing. The geolocation data is used for identifying the address or location of a retailer in which the crypto transaction is processed. The wallet 1104 can support different crypto currencies. Referring now to FIG. 11A, a user is onboarded in the software wallet 1104. The interface 1106 provides the options of creating a new wallet 1108 and selecting an already existing wallet 1110 from the list of existing wallets 1112.

In FIG. 11B, the interface 1114 shows importation of the crypto currency private key for public address resolution. The key is securely imported using the import button 1116. In FIG. 11C, the interface 1118 shows importation of the crypto currency private key from multi-factor hardware design storage using the option 1120.

FIG. 11D displays a list 1122 of different cryptocurrency transactions and corresponding balances. FIG. 11E displays a list 1124 of Ethereum token balances. Ether (ETH) is the native token used by the Ethereum blockchain and network as an internal payment system. ERC-20 is the standard for creating smart contract-enabled fungible tokens to be used in the Ethereum ecosystem. FIG. 11F displays the return of a private key address 1126 that was generated on the multifactor hardware device. Different keys can be returned using the software wallet 1104. FIG. 11G displays the HOTP 8 digit pin 1128 received from the hardware device 908. In FIGS. 11H and 11I, the software wallet implements geolocation and displays Canada (first location) 1130 outside of restricted area and the United States (second location) 1132 within the restricted area for performing transactions using the software wallet.

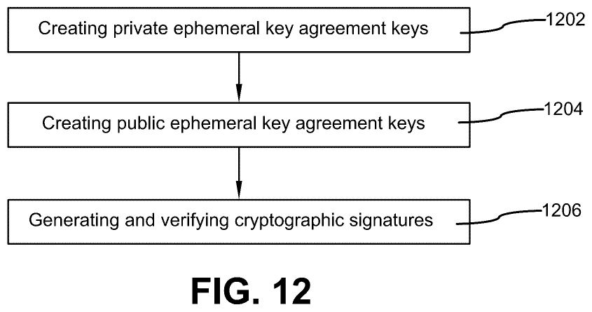

FIG. 12 illustrates a process of secure data transmission and record retention using a decentralized networking platform in accordance with the disclosed architecture. The present embodiment leverages a decentralized network structure for providing a secure environment for data handling and transactions, which can be particularly beneficial for institutions requiring high levels of privacy. The method can be implemented by the multifactor device 908 and may provide a “single key” to encrypt user's data before submitting to the blockchain. The system uses asymmetric cryptography which offers enhanced security, making it suitable for secure communication over untrusted networks. A private ephemeral key agreement keys are the private keys within asymmetric key pairs. The public key is potentially known by any party, but the private key is kept secret by its owner. The private keys can be used only once to establish one or more session keys (for encryption, MACs, etc.) or other cryptographic parameters (like Initialization Vectors for encryption modes) and then discarded (Step 1202). Then, public ephemeral key agreement keys are generated (Step 1204). Each transaction generates a new public key, enhancing security and cannot be used to decrypt past or future transactions. In the next step, a cryptographic signature is generated and is verified for the ephemeral public keys and private keys for use in the software wallet (Step 1206).

When a single embodiment is described herein, it will be readily apparent that more than one embodiment may be used in place of a single embodiment. Similarly, where more than one embodiment is described herein, it will be readily apparent that a single embodiment may be substituted for that one method or device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “facility planning and monitoring system”, “facility planning system”, “planning system”, and “system” are interchangeable and refer to the facility planning and monitoring system 100 of the present invention.

Notwithstanding the forgoing, the facility planning and monitoring system 100 of the present invention can be of any suitable size and configuration as is known in the art without affecting the overall concept of the invention, provided that it accomplishes the above stated objectives. One of ordinary skill in the art will appreciate that the facility planning and monitoring system 100 as shown in the FIGS. are for illustrative purposes only, and that many other configurations of the facility planning and monitoring system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A facility planning and monitoring system comprising:
a mobile application;
an electronic user device;
a server;
a communication network;
a view module;
a facility management module;
a settings module;
a facility camera; and
an object detector;
wherein said application accesses said server using said communication network;
wherein said server having said view module for providing views of live traffic within a facility;
wherein said facility camera providing a live stream view of said facility managed by said facility management module;
wherein said live stream view is a live stream video uniquely identified based on an IP stream address of said facility camera;
wherein said object detector identifies an object within said live stream video; and
further wherein said object is selected from the group consisting of a firearm, a pistol, a shotgun, and an assault rifle.

2. The facility planning and monitoring system of claim 1, wherein when said object is detected is said live stream video, said live stream video stream is automatically recorded including recording an area location, a date, and a time of occurrence of said object detection.

3. The facility planning and monitoring system of claim 2, wherein said facility management module having a plurality of submodules.

4. The facility planning and monitoring system of claim 3, wherein said settings module establishes authorized users and administrative functions to said authorized users.

5. The facility planning and monitoring system of claim 4 further comprising a floor plan view providing a 360-degree view of a floor of said facility, wherein said floor plan view displaying a layout of the floor of said facility.

6. The facility planning and monitoring system of claim 5, wherein said authorized user is an administrator, further wherein said administrator switches views between said floor plan views of different sections of said facility.

7. The facility planning and monitoring system of claim 6, wherein at least a first said authorized user receives said alert activated by another authorized user upon detection of said object.

8. The facility planning and monitoring system of claim 7, wherein said alert is selected from the group consisting of an SMS message and an email.

9. The facility planning and monitoring system of claim 8, wherein said facility management module having a facility setup submodule for creating, editing, and removing of one or more said facility in the facility planning and monitoring system.

10. A facility planning and monitoring system comprising:
a mobile application;
an electronic user device;
a server;
a communication network;
a view module;
a facility management module;
a settings module;
a notification client;
a facility camera; and
an object detector;
wherein said application accesses said server using said communication network;
wherein said server having said view module for providing views of live traffic within a facility;
wherein said facility camera providing a live stream view of said facility managed by said facility management module;
wherein said live stream view is a live stream video uniquely identified based on an IP stream address of said facility camera;
wherein said object detector identifies a weapon object within said live stream video;
wherein said notification client receives a push notification from said server; and
further wherein said push notification is an alert when said weapon object is detected.

11. The facility planning and monitoring system of claim 10, wherein said weapon object is selected from the group consisting of a firearm, a pistol, a shotgun, and an assault rifle.

12. The facility planning and monitoring system of claim 10, wherein when said weapon object is detected is said live stream video, said live stream video stream is automatically recorded including recording an area location, a date, and a time of occurrence of said weapon object detection.

13. The facility planning and monitoring system of claim 12, wherein said facility management module having a plurality of submodules.

14. The facility planning and monitoring system of claim 13, wherein said settings module establishes authorized users and administrative functions to said authorized users.

15. The facility planning and monitoring system of claim 14 further comprising a floor plan view providing a 360-degree view of a floor of said facility, wherein said floor plan view displaying a layout of the floor of said facility.

16. The facility planning and monitoring system of claim 15, wherein said authorized user is an administrator, further wherein said administrator switches views between said floor plan views of different sections of said facility.

17. The facility planning and monitoring system of claim 16, wherein at least a first said authorized user receives said alert activated by another authorized user upon detection of said weapon object.

18. The facility planning and monitoring system of claim 17, wherein said alert is selected from the group consisting of an SMS message and an email.

19. The facility planning and monitoring system of claim 18, wherein said facility management module having a facility setup submodule for creating, editing, and removing of one or more said facility in the facility planning and monitoring system.

20. A facility planning and monitoring system comprising:
a mobile application;
an electronic user device;
a server;
a communication network;
a view module;
a facility management module;
a settings module;
a notification client;
a facility camera; and
an object detector;
wherein said application accesses said server using said communication network;
wherein said server having said view module for providing views of live traffic within a facility;
wherein said facility camera providing a live stream view of said facility managed by said facility management module;
wherein said live stream view is a live stream video uniquely identified based on an IP stream address of said facility camera;
wherein said object detector identifies a weapon object within said live stream video;
wherein said notification client receives a push notification from said server;
wherein said push notification is an alert when said weapon object is detected; and
further wherein said notification client correlates said object detector with a location of said facility camera that detected said weapon object.
